(19) United States
(12) Patent Application Publication
(10) Pub. No.: US 2004/0112781 A1
(43) Pub. Date: Jun. 17, 2004

(54) Package

(76) Inventors: Niklas Hofverberg, Goteborg (SE); Mats Wendel, Molnlycke (SE)

Correspondence Address: BIRCH STEWART KOLASCH & BIRCH, PO BOX 747, FALLS CHURCH, VA, 22040-0747, US

(21) Appl. No.: 10/363,532

(22) PCT Filed: Oct. 10, 2001
(86) PCT No.: PCT/SE01/02195

(30) Foreign Application Priority Data
Oct. 12, 2000 (SE) 0003672-3

(51) Int. Cl. B65D 83/10

(52) U.S. Cl. 206/438; 206/363

(57) ABSTRACT

The invention relates to a package (1) for a device (2), particularly an implant. The package (1) comprises a protective housing (3) and a device holder (4) arranged to support the device (2). The device holder (4) is connected to the protective housing (3) for movement in relation thereto between a device storage position and a device removal position. The package (1) is further provided with guide means (5) defining a predetermined path (6) for said movement of the device holder (4) in relation to said protective housing (3), said predetermined path (6) being arranged so that the device (2), when supported by the device holder (4), is kept apart from the protective housing (3).

### TECHNICAL FIELD OF THE INVENTION

The invention relates to a package for a device, particularly an implant, comprising a protective housing.

### BACKGROUND ART

Devices that are to be kept sterile, such as implants for implantation into a living body, are normally packaged and transported in a container assembly or kit. The container maintains the implant in a sterile environment during transport and storage and is opened just before the implant is to be used, for example during a surgical implantation procedure.

In many instances the interior of the container must be kept sterile until the opening of the container and removal of the device. Further, it is necessary that the device can easily be removed from the container by the person handling the device, such as a surgeon or a dentist.

Thus, the general demands placed on packages of this kind are to

ensure sterility during transport and storage and

provide practical handling of the device.

To this end, a number of different containers have been proposed over the years, se e.g. U.S. Pat. No. 4,856,648, U.S. Pat. No. 5,368,160, U.S. Pat. No. 5,538,428, U.S. Pat. No. 5,558,230, U.S. Pat. No. 5,755,575, WO 98/26726, U.S. Pat. No. 4,671,410, and U.S. Pat. No. 4,712,681.

One prior-art type of container is a double box container, comprising a primary, outer gasket being sealable so that its interior can be protected from outer contamination. The outer gasket is adapted to contain a secondary, inner package containing a sterilised device.

The double boxes of the container provide two levels of cleanness, which is advantageous when handling the container. When the device is to be used, the container is initially moved to a non-sterile zone, where the outer gasket is removed. Thereafter, the inner package is transferred to a sterile zone where the inner package is opened and the sterilised device is removed.

The double box container construction is commonly seen in packages intended for sterile devices. The present invention is especially, but not exclusively, useful for the inner package of a double box container, that is the package closest to the sterile device. However, the invention could also be used for a single box container, omitting the primary, outer gasket.

U.S. Pat. No. 4,856,648 (Krueger) discloses a common type of double box container. A cylindrical primary, outer container is sealed with a conventional cap so that its interior is kept sterile. The primary container is used to hold a vial-shaped secondary container. At its open end, the vial-shaped secondary container is provided with a removable closure or lid supporting the implant, such that the implant during storage is with the closure or lid only—not with the surrounding container walls. When taking out the implant, the closure is separated from the vial-shaped container and used as a handle for removing the implant from the container. The closure is also practical to use as a handle when manipulating the device during the subsequent implantation procedure. Other packages are disclosed in U.S. Pat. No. 5,368,160 (Leuschen), U.S. Pat. No. 5,538,428 (Staubli), U.S. Pat. No. 5,558,230 (Fischer) and U.S. Pat. No. 5,755,575 (Biggs).

In other variants of these constructions, the sterile device is initially connected to a manipulator. The manipulator can in turn be supported in the inner package. The manipulator is adapted to constitute a practical gripping means for taking out and handling the sterile device.

In, for example, WO 98/26726 (Institut Straumann AG) a package of the above mentioned kind is disclosed. An implant is connected to a fitting socket, which in turn is connected to a manipulator. An intermediate wall provided in the package supports the fitting socket, and thus the implant. In this way, the implant is supported inside the package with virtually no contact to the package itself.

All of the packages described above suffer from a disadvantage in that, when the sterile device is removed from the inner container or ampoule, there is a risk of inadvertent wobbling of the device, causing it to touch the inner walls of the container or ampoule. In such a situation, the device surface may be contaminated by residues of the package material. This is of particular importance when the device is an implant intended for implantation into a patient. Package material contamination could disturb the osseointegration of the implant into the bone of a patient, once it has been implanted. Therefore, the requirement for clean implant surfaces before implantation is very strict. In this context, it is thus extremely important to protect the implant surface from foreign matter during the complete handling procedure, including the transport, the storage and finally the removal of the implant from the package.

This problem of contamination of the device by particles from the package material is hereinafter referred to as the material contamination problem.

U.S. Pat. No. 4,671,410 (Hansson et al) discloses a package for ensuring the cleanness of an implant held therein, solving the material contamination problem to a certain extent. The implant is screwed into an inner capsule in order to be firmly held in tight contact with the capsule material. The material contamination problem is reduced by the fact that the capsule is made of the same material as the implant. If any capsule material particles should appear on the implant surface, they are therefore not likely to have such a deteriorating effect on the osseointegration of the implant as particles of another material would have. The package is further provided with a hermetically sealed outer casing surrounding the capsule, and a positioning member for positioning the capsule inside the outer casing.

However, the package disclosed in U.S. Pat. No. 4,671,410 presents several drawbacks.

First, the solution is expensive since the capsule must be made of the same material as the implant, which is usually a rather expensive material such as titanium or a titanium alloy.

Second, there is a cosmetic problem since it has been found that implants that have been taken out from this type of capsules exhibit a scratched surface, looking worn, probably due to the wear when screwed into the capsule material. This rugged look is not appreciated on the market, and constitutes an obstacle to commercial success of the implant.

Another package of the above-mentioned capsule type is disclosed in U.S. Pat. No. 4,712,681 (Br\dot{a}nemark et al).

The above-mentioned problems relating to the handling of the device are particularly pronounced when the device and the package have small sizes. The handling of a dental implant is evidently more delicate than the handling of for example an orthopaedic implant.

It is an object of the present invention to provide a package for a device, particularly an implant, which has advantages over the packages hitherto proposed in the art, in particular regarding one or more of the above identified problems.

### SUMMARY OF THE INVENTION

The object of the invention is achieved by a package according to the introduction, further comprising a device holder arranged to support the device and being connected to the protective housing for movement in relation thereto between a device storage position, in which the device is protected by the protective housing, and a device removal position; and guide means defining a predetermined path for said movement of the device holder in relation to said protective housing, said predetermined path being arranged so that the device, when supported by the device holder, is kept apart from the protective housing.

In the present application, the “device” supported by the device holder could be a single device, such as an implant, but also a multi-part device, such as an implant connected to a manipulating means. Preferably, only the manipulating means is to be in contact with the package.

The term “guide means” is to be understood as any means performing the function of establishing said predetermined geometrical path for the movement of the device holder in relation to the protective housing.

As a result of the predetermined path being arranged so that the device, when supported by the device holder, is kept apart from the protective housing, there is no risk of particles from the housing material coming into contact with the device during the removal of the device from the package. Thus, the invention provides a solution to the above-mentioned material contamination problem.

Further, as a result of the absence of any direct contamination contact between the protective housing and the device, also the above-mentioned cosmetic problem of scratches occurring on the implant is solved. The term “protective housing” is to be understood as a housing protecting the device mainly from touch when handling the package, that is a handling protection. It is not necessary, although not excluded, that the protective housing should also protect the device from foreign matter, such as dust, thus providing a cleanness protection. When the housing is provided with an opening as stated above, it would provide a sufficient handling protection. However it would not completely protect the cleanness of the device.

Since the device is kept apart from the protective housing, the protective housing can be made from any material providing the necessary characteristics for sterilisation, durability, etc. Thus, a relatively inexpensive material, such as plastic, can be used.

The package according to the invention is well suited for use as an inner package in a double box container for ensuring sterility.

The package according to the invention is particularly useful for small-sized devices, such as dental implants, since the practical difficulties usually related to the handling of such devices can be greatly diminished.

According to an embodiment of the invention, the protective housing is provided with an opening directed transversely to the predetermined path and through which opening the device holder is movable between said storage position and said removal position.

The device holder being movable through an opening in the protective housing is a practical solution for providing an predetermined path in which the device supported by the device holder is kept apart from the protective housing. In such a manner, the protective housing can be wholly or partly removed from the device supported by the device holder, which facilitates extraction of the device from the package with no inadvertent contact between the device and the protective housing.

Preferably, the device removal position is a position in which the device supported by the device holder is located completely outside the protective housing, which diminishes the risk of inadvertent contact between the device and the holder.

Alternatively, the device removal position is a position in which the device supported by device holder is located partly outside the protective housing, thus being accessible and extractable from the part of the device holder not protected by the protective housing. Preferably, a major part of the device supported by the device holder is located outside the protective housing in the device removal position, so that the device can easily be removed from the package without coming into contact with the protective housing.

Preferably, the device removal position is a position in which the device holder extends from the protective housing so that the device is accessible in the device holder. This construction is particularly advantageous for keeping the device supported by the device holder spaced apart from the protective housing when extracted from the package.

According to a preferred embodiment of the invention, the protective housing has an elongated shape.

Advantageously, the protective housing has a short end, said short end being provided with an opening through which the device holder is movable along said predetermined path.

Preferably, said predetermined path is provided essentially parallel to the longitudinal direction of the protective housing.

Advantageously, said movement of the device holder is a sliding motion.

In one embodiment of the invention, the guide means comprise a slide member and a slide track. The slide member and slide track enable a sliding motion between the protective housing and the device holder along the predetermined path. It is appreciated that the construction of the slide track and slide member can easily be made so as to control the predetermined path in the desired manner. It is also understood that the sliding motion provided by the guide means according to this embodiment can easily be controlled and ensures a proper motion between the protective housing and the device holder along the predetermined path.

Preferably, adjacent portions of the protective housing and the device holder, respectively, have complementary shapes forming said slide member and said slide track, or vice versa. Thus, the slide member and slidetrack may constitute integrated parts of the protective housing and the device holder. This results in a simple construction, which is advantageous both for manufacturing purposes and for providing a well functioning package in use.

By slide track is meant a means which direction of extension determines the direction of the sliding motion. By slide member is meant a device being adapted to slide along the slide track during the sliding motion. Thus, a slide track could be, for example, a groove, a reel or an edge. A slide member could also be a groove, a reel or an edge, but also a knob or a hook. These examples are non-limiting examples only.

It may be noted that while the extension of the slide track determines the direction of the sliding motion, the extension of the predetermined path would also be affected by the extension or shape of the slide member.

In an embodiment of the invention, the protective housing is provided with a slide track and the device holder comprises a slide member being movable along said slide track

According to one embodiment of the invention, the package has an outer wall, the protective housing forms said outer wall of the package, and the device holder is provided adjacent to said outer wall, so that the device is protected by said outer wall when the device holder is in the storage position.

In this embodiment, the device is protected by an outer wall provided by the protective housing when the device holder is in the storage position. An outer wall provided by the protective housing results in a simple and efficient protection for the device in the storage position.

In another embodiment of a package according to the invention, when the device holder is in the storage position, the package has an outer wall, the protective housing comprises a first wall part, and the device holder comprises a second wall part, such that the first wall part and the second wall part together form said outer wall for protecting the device when the device holder is in the storage position.

In this embodiment, the complete outer wall of the package when in the storage position is thus provided by at least two parts. The protective housing comprises a first wall part and the device holder comprises a second wall part. It is appreciated that when the device holder is moved away from the storage position, the complete outer wall of the package will no longer be intact.

In a specific variant of a package according to the above embodiment, when the device holder is in the storage position, the package presents an outer wall having four side walls, the protective housing comprises a first wall part having three side walls, and the device holder comprises a second wall part having one side wall, such that the first wall part and the second wall part together form said outer wall having four side walls for protecting the device when the device holder is in the storage position.

The four-walled package that results from the above embodiment is easily stored and handled. The three-walled protective housing and the one-walled device holder provide package parts that are easy to grip by the user hand during the motion of the parts between the storage and the removal position.

Preferably, at least one of the protective housing and the device holder is provided with gripping means for gripping when effecting the manual movement of the device holder along the predetermined path.

Such gripping means facilitates the opening of the package.

According to an embodiment of the invention, the protective housing is provided with an access opening through which at least a part of the device is accessible when the device holder is in the device storage position.

Such an access opening could be used to perform adjustments of the device while it still rests in the package. An example of an adjustment is the coupling of a manipulator means to the device.

This presents an advantage relative to the prior art type disclosed in U.S. Pat. No. 4,856,648, where the device is supported by a closure that is used as a handle for extracting the device. Using this type of package, the person handling the device has to grip the closure in order to extract the device, which makes further adjustments at the end of the device difficult. According to the proposed embodiment, it is possible to perform different adjustments at the end of the device while the device is still held in by the device holder in the storage position. Such an adjustement could be connecting an instrument or a manipulating means to the end of the device. This is thus a practical solution giving the person handling the device the option to adjust the end of the device to his own needs by a simple procedure.

Advantageously, the device holder is arranged to support the device from a generally transverse direction relative to a longitudinal direction of the device. By generally transverse direction, it is in this context meant a direction enabling the adaption of the end of t [symbol] device by, for example, connecting various instruments [symbol] it.

Such an arrangement would facilitate access of par [symbol] of the device when supported by the device holder, eith [symbol] in the storage position or the removal position.

Advantageously, the package could comprise locking means for avoiding unintentional movement of the device holder from the storage position. Locking means could also be provided to avoid complete separation of the device holder from the protective housing.

Such locking means could be mechanical, frictional [symbol] enhancing or snap lock means, or a combination thereof.

A package according to the invention could advantageously be provided in an outer sealing gasket in order to provide a double box container.

The outer gasket could in turn initially be provid [symbol] with an outer sealing foil in order to ensure cleanness and to provide visible evidence for an unbroken container.

### BRIEF DESCRIPTION OF THE DRAWINGS

The invention will hereinafter be described with reference to the preferred embodiments as illustrated [symbol] the drawings, given as examples only and not to be inte [symbol] preted as limiting the scope of protection claimed. Lik [symbol] parts have the same reference numerals throughout the embodiments.

FIG. 1a shows a first embodiment of a package according to the invention containing a dental implant, with a device holder located in a storage position.

FIG. 1b shows the package in FIG. 1a with the device holder located in a removal position, where the implant is removable as indicated by the arrow.

FIGS. 2a and 2b show a second embodiment of a package according to the invention with the device holder being in a storage position and a removal position, respectively.

FIG. 3a is an exploded view of a third embodiment of a package according to the invention with a surrounding sealing gasket.

FIG. 3b is a longitudinal cross-sectional view of the package in FIG. 3a with the device holder being in the removal position.

FIG. 3c is a side view of the device holder of the package in FIG. 3a.

FIG. 3d is a top plan view of the device holder of the package in FIG. 3a.

FIG. 3e is a side view of the protective housing of the package in FIG. 3a.

FIG. 3f is a top plan view of the protective housing of the package in FIG. 3a.

FIG. 4 shows a fourth embodiment of a package according to the invention.

FIG. 5 shows a fifth embodiment of a package according to the invention.

### DETAILED DESCRIPTION OF PREFERRED EMBODIMENTS OF THE INVENTION

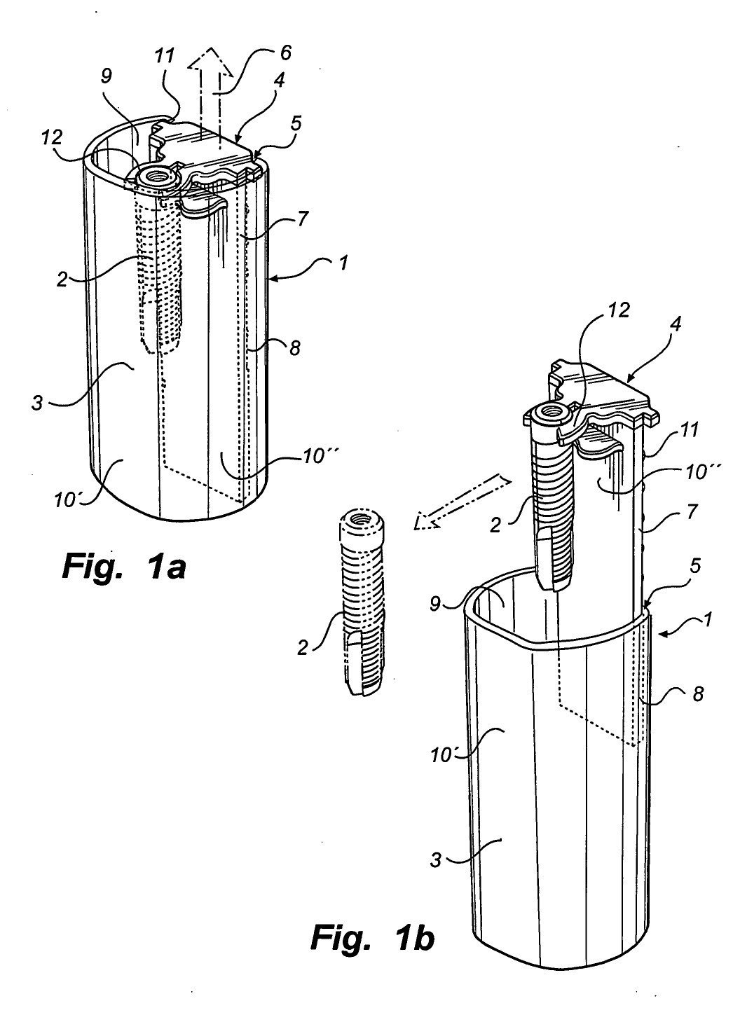

In FIGS. 1a and 1b, a first embodiment of the package according to the invention is depicted. The package 1 is arranged to contain a device 2, here in the form of a dental implant. The package comprises an elongated protective housing 3 and a device holder 4 that is arranged to support the implant 2. The device holder 4 is connected to the protective housing 3 and movable between a device storage position (FIG. 1a) and a device removal position (FIG. 1b). The package 1 further comprises guide means 5 arranged to define a predetermined path 6 (indicated by the dashed arrow in FIG. 1a) for device holder 4 relative to the protective housing the movement of the 3.

The predetermined path 6 is arranged so that the implant 2, when supported by the device holder 4, is kept apart from the protective housing 3.

In the storage position (FIG. 1a) the implant 2 held by the device holder 4 is effectively protected by the protective housing 3 during transport and storage.

In this embodiment, the removal position (FIG. 1b) is a position in which the implant 2 held by the device holder 4 is free from the protective housing 3 and, thereby, easily accessible and extractable from the package 1. Preferably, the implant 2 is separated from the device holder 4 in the direction indicated by the arrow in FIG. 1b.

It is notable that the device 2 will be moved in a first direction (along the predetermined path) in order to reach the removal position, and then in a second direction, being transverse to the first direction, to be removed from the package.

According to the invention, the “guide means” are to be understood as any means performing the function of establishing a predetermined geometrical path 6 for the movement of the device holder 4 in relation to the protective housing 3. In the embodiment shown in FIGS. 1a and 1b, the guide means 5 comprise a slide member 7 and a slide track 8, and said predetermined path 6 is determined by the extensions of said slide track 8 and slide member 7.

In this embodiment, the slide member 7 constitutes an integral part of the device holder 4. The slide track 8 consists of a slot or lateral opening formed in the protective housing 3. The edges of said slot are adapted to receive the two opposite side edges of the slide member 7, respectively.

In order to hold the slide member 7 in place in the slide track 8 during storage and opening of the package, the slide track 8 is provided with retaining means (not shown in the drawing). Preferably, the retaining means could comprise grooves extending along the edges of the slot 8.

The construction with a slide member 7 and a slide track 8 results in that the movement of the device holder 4 between its storage position in FIG. 1a and its removal position in FIG. 1b along the predetermined path 6 will be an easily controllable sliding movement.

In this embodiment, the predetermined path 6 is essentially parallel to the longitudinal direction of the elongated protective housing 3. The protective housing 3 presents an opening 9 which extends transversely to the predetermined path 6 and through which the device holder 4 is movable. In the removal position, the device holder 4 extends from the protective housing 3 through the opening 9 to such an extent that the implant 2 is readily accessible in the device holder 4. In the illustrated embodiment, the implant 2 is located completely above opening 9 in the removal position.

The protective housing 3 comprises a first wall part 10′ and the device holder 4 comprises a second wall part 10″, together forming an outer wall 10 for protecting the device 2 when the device holder 4 is in its storage position in FIG. 1a. When the protective housing 3 and the device holder 4 are moved apart, the outer wall 10 will no more be complete.

In this embodiment, the second wall part 10″ does also constitute the slide member 7 of the guide means 5. The second wall part 10″ is further provided with external gripping means 11 for facilitating the manoeuvring when opening the package.

It should be noted that only a small part of the surface of the implant 2 is in contact with the device holder 4 when contained in the package. This is an advantage, in particular when the device is provided with a sensitive, prepared surface, which is the case for certain types of implants.

The device holder 4 supports the implant 2 from a transverse direction relative to the device 2. This means that it is possible to perform adjustments at the end of the device while it is still resting in the device holder 4.

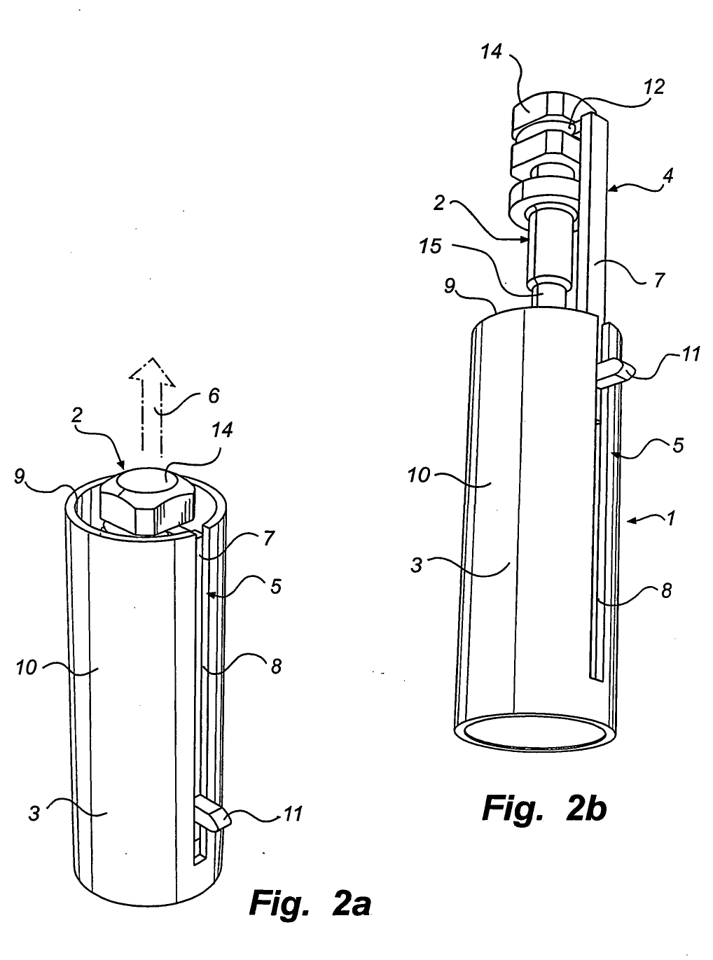

In FIGS. 2a and 2b, a second embodiment of a package according to the invention is shown. As can be seen from FIG. 2b, in this embodiment the device 2 supported by the device holder 4 is only partly free from the protective housing 3 when the holder 4 is in the removal position. However, the device 2 should be in such a position that it is possible to extract it from the package 1 without contact between the device 2 and any package parts.

In the second embodiment, the protective housing 3 is cylindrical and forms by itself the outer wall 10 protecting the device 2. The device holder 4 is provided adjacent to said outer wall 10, so that the device 2 is protected by said outer wall 10 when the device holder 4 is in its storage position in FIG. 2a. The guide means 5 comprise a narrow groove 8 (slide track) formed in the housing wall 3 and an elongated bar 7 (slide member), which is integrated with the device holder 4.

In the first embodiment shown in FIG. 1a and 1b, the device 2 is in the form of an implant. In the second embodiment shown in FIG. 2a and 2b, the device 2 comprises an implant 15 connected to a manipulating device 14. More specifically, the actual implant 15 is never in direct contact with the device holder 4, but only indirectly via the manipulating device 14.

In this second embodiment of the invention, there are retaining means (not seen in the drawing) provided for holding the slide member 7 in place in the slide track 8 during storage and opening of the package. The retaining means comprise in this case a bottom part of the device holder 4. Said bottom part has a transversal extension so as to snugly fit inside the housing 3, and a longitudinal extension being large enough so that the bottom part functions to stabilise the movement of device holder 4 relative to the housing 3.

If the device holder 4 is completely separated from the housing 3, the bottom part can function as a platform on which the device holder 4 can be placed. Then, there is an option to first separate the device holder 4 from the housing 3 and place it on for example a table, and thereafter remove the device 2 from the device holder 4.

In this second embodiment, the retaining element could be varied and, for example, comprise longitudinal edges of the housing 3, which protrude over the slide track, in between which edges the slide member 7 can be installed.

The package could also be provided with removable sealing caps located on the top and bottom ends of the protective housing. Such caps would provide an additional cleanness protection to the handling protection already provided by the housing. Such extra cleanness protection could also be provided in the embodiments shown in FIGS. 1a and 1b.

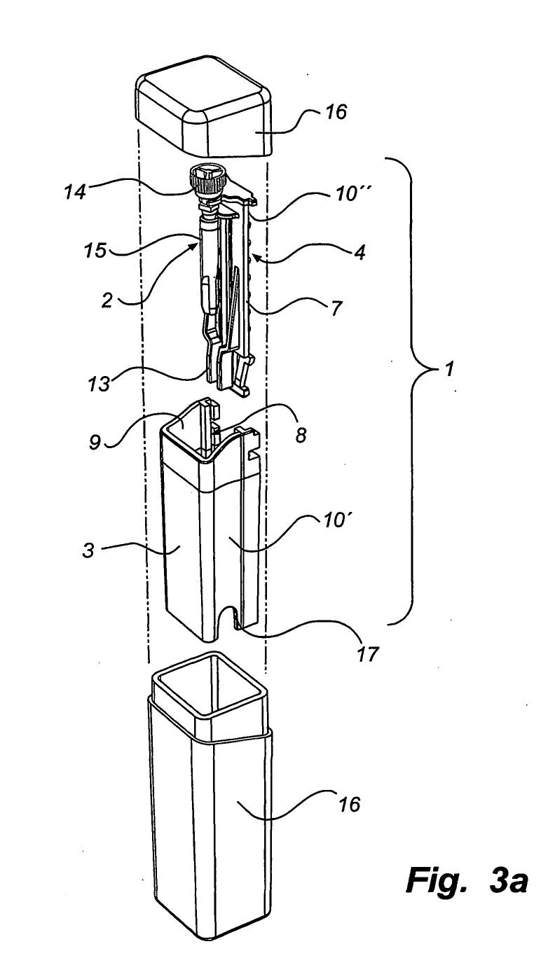

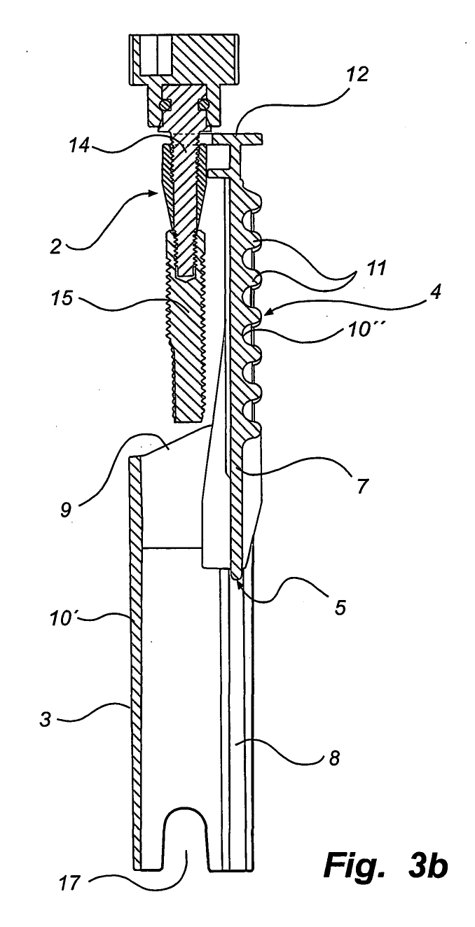

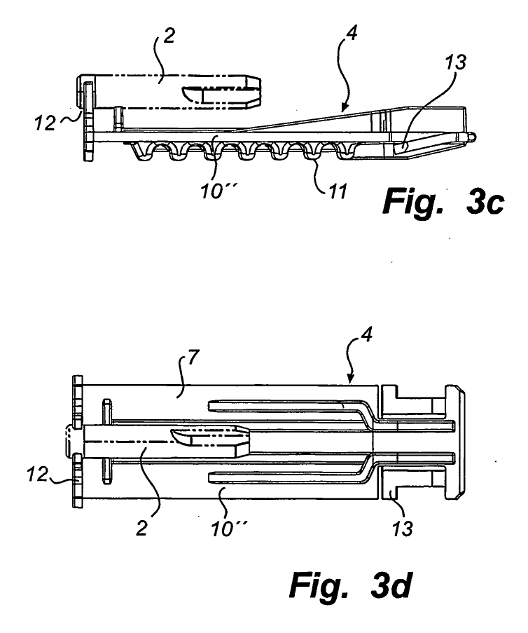

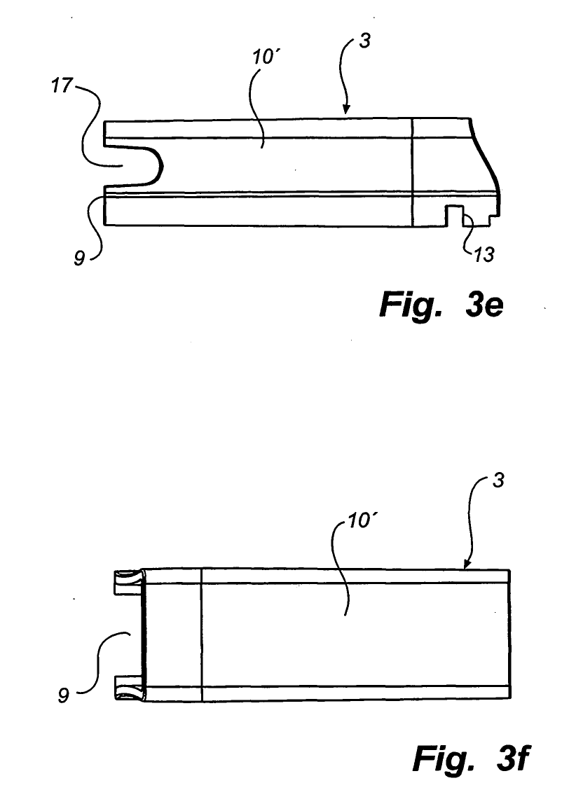

In FIGS. 3a-3f, a third, preferred embodiment of a package according to the invention is shown. Like features has been give the same reference numerals as in FIGS. 1a and 1b.

Referring now to FIGS. 3a-f, a third embodiment of the invention be described. In the exploded view of FIG. 3a, the protective housing 3 and the device holder 4 that constitutes the package 1 are seen separately. An outer two-part sealing gasket 16, in which the package 1 could be contained in order to form a double box type container, is also depicted.

In the third embodiment, the protective housing 3 forms a U-shaped first wall part 10′ and the device holder 4 forms a second outer wall part 10″ together forming a complete outer wall part 10 when the device holder 4 is in its storage position, in a way similar to the first embodiment shown in FIGS. 1a and 1b.

The package 1 shown in FIGS. 3a-3f is provided with a releasable snap lock means 13 which serves to hold the device holder 4 and protective housing 3 when in the removal position.

In the embodiment of the package according to the invention shown in FIGS. 3a-3f, the guide means 5 comprise a slide member 7 and a slide track 8, and said predetermined path 6 is determined by the extensions of said slide track 8 and slide member 7.

In this embodiment, the slide member 7 constitutes an integral part of the device holder 4. The slide track 8 is constituted by a slot or lateral opening provided in the protective housing 3. The edges of said slot are provided with longitudinally extending grooves adapted to receive the two opposite side edges of the slide member 7, respectively. The grooves thus function as retaining elements for controlling the location and motion of the slide member 7 in the slide track 8.

In FIG. 3b, the third embodiment of the invention is shown in an removal position. In this view, it is particularly evident how the holder 12 of the device holder 4 supports the device 2 by means of a cradle structure. In this case, the device comprises an implant 15 and a manipulating device 14. It can be seen that only the manipulating device 14 is in contact with the device holder 4.

The manipulating means 14 shown in FIG. 3b comprises two parts: a first part connected to the implant 15 and a second part connected to the first part and shaped so as to be easy to handle. Since the device holder supports the device from a transverse direction relative to the device, it is possible, for example, to release the second part of the manipulating means 14 from the first part while the device 2 rests in the device holder 4. When the second part is removed, an instrument to be used when implanting the implant into the jaw of a patient could be attached to the first part.

FIG. 3c is a side view of the device holder 4 of the package in FIG. 3a. In this view, the gripping means 11 of the device holder, comprising a series of elongated protrusions, are clearly visible.

In FIGS. 3c and 3d, it is demonstrated how the device holder 4 could support the device 2 when the device 2 is a single part device, such as an implant. It could be noted that only a small part of the implant surface is in contact with the device holder 4.

The snap lock means 13 is seen to comprise two parts (FIG. 3d and FIG. 3e). The first part is the two locking indentations provided in the protective housing 3. The second part comprises two resilient wing-shaped structures taken out of the material in the device holder 4. As seen in FIG. 3c, the wing-shaped structures are pre-shaped so as extend from the sides of the device holder 4, which sides are to fit into the grooves of the housing 3. When the package is assembled, and the device holder is fit into the grooves of the protective housing 3, the wing-shaped structures will be pressed into the grooves. When the device holder is in the storage position, the wings will thus press slightly against the grooves of the protective housing. As the device holder 4 is moved relative to the protective housing 3, this slight pressure will provide a frictional resistance, which ensures that the motion of the device holder 4 can easily be controlled. When the device holder 4 is moved to the position where the wings meet the indentations of the protective housing 3, the wings will snap into the indentations and thus provide a stop for continuous motion of the device holder 4 away from the protective housing 3.

In the embodiment of the invention shown in FIGS. 3a-3f, the snap lock means are arranged to prevent complete separation of the device holder 4 from the protective housing 3. In other variants of the invention, a releasable locking means could be provided which locks the device holder 4 in the storage position, to avoid unintentional motion of the device holder 4 relative to the protective housing 3.

FIG. 3d is a top plan view of the device holder 4 of the package 1 in FIG. 3a. In this figure the wings of the snap lock means 13 are clearly visible.

FIG. 3e is a side view of the protective housing 3 of the package 1 in FIG. 3a. The indentation of the snap lock means 13 is clearly seen at the side of the housing 3.

FIG. 3f is a top view of the protective housing 3 of the package 1 in FIG. 3a. At the top of the protective housing 3 it can be seen that two of the side walls of the protective housing 3 are inwardly curved. This is advantageous for the gripping and handling of the protective housing 3.

In two opposite walls of the protective housing, indentations 17 are provided. These indentations are used to facilitate mounting of the package 1 in a rack or the like during assembling or opening of the package.

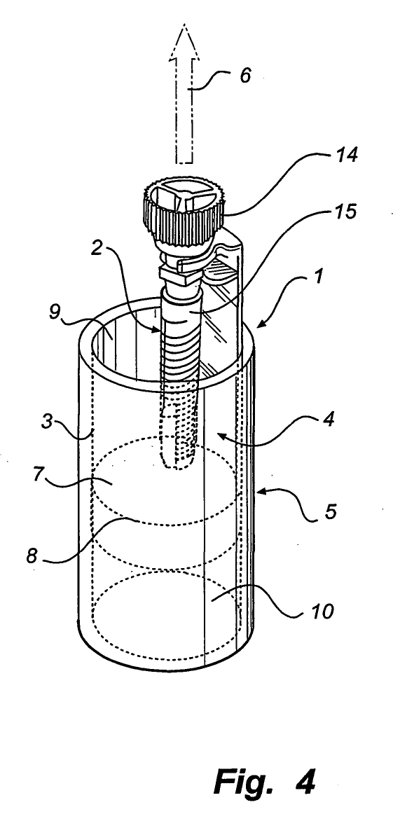

In FIG. 4 a fourth embodiment of the invention is depicted. Like parts have been give the same reference numerals as in the previous figures.

The embodiment of FIG. 4 resembles to the embodiment shown in FIGS. 2a-2b. The main difference is the construction of the guide means 5. In this fourth embodiment, the guide means consist of a slide member 7 and a slide track 8 as in the second embodiment shown in FIGS. 2a-2b. However, the slide track 8 is formed by the inside of the integral wall 10 of the protective housing 3. The slide member 7 is a cross-sectional part snugly fit into the cylindrical protective housing 3. In the storage position, the cross-sectional slide member 7 is situated at the end of the protective housing 3. The slide member 7 is then pressed from below, in the direction of the arrow showing the predetermined path 6, in order to reach a removal position in which the device 2 is accessible.

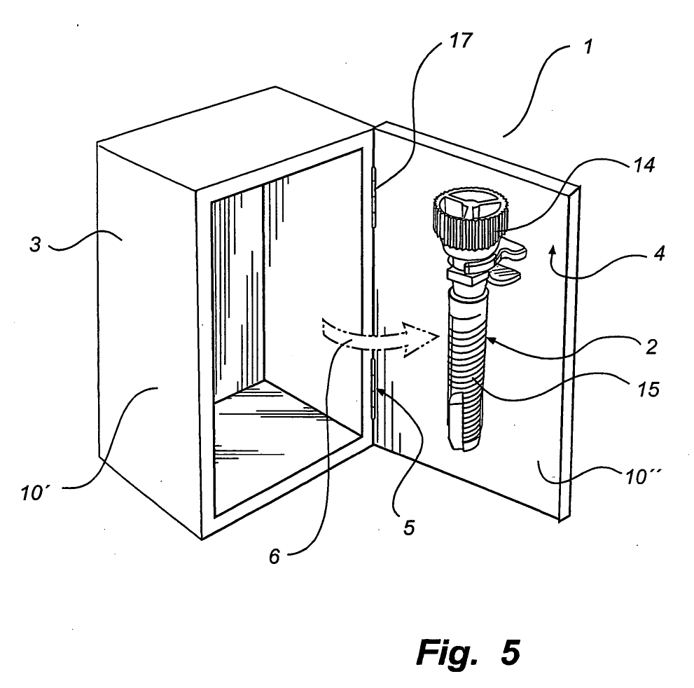

In FIG. 5, a fifth embodiment of the invention is shown.

The package comprises a protective housing 3 and a device holder 4 that is arranged to support the device 2. The device holder 4 is connected to the protective housing 3 and movable between a device storage position, and a device removal position, which is shown in FIG. 5. Guide means 5 are arranged defining a predetermined path 6 (indicated by the dashed arrow) for the movement of the device holder 4 relative to the protective housing 3.

The predetermined path 6 is arranged so that the device 2, when supported by the device holder 4, is kept apart from the protective housing 3.

In this embodiment, the guide means 5 comprise hinge means 17 provided so as to connect the protective housing 3 and the device holder 4.

The protective housing 3 comprises in this embodiment a first wall part 10′ and the device holder comprises a second wall part 10″ complementarily shaped to the first wall part 10′ so that, in the storage position, the wall parts 10′ and 10″ form an integral wall to protect the device 2.

It is of course not necessary that the wall formed by the two wall parts 10′ and 10″ in the storage position is a completely closed wall. It is possible to protect the device 2 in the storage position of the package also by a partly open wall.

The device 2 is held by a holder 12 provided on the wall part 10″ of the device holder 4.

When in the storage position, the device 2 is kept inside the box formed by the wall parts 10′ and 10″ of the protective housing 3 and the device holder 4, respectively. In order to reach a removal position, the device holder 4 is swung open, whereby the swinging motion is controlled by the hinge means 17. During said swinging motion, the device holder 4 will follow the predetermined path 6, and as can be readily appreciated from the drawings, the device 2 will be kept out of contact with the protective housing all the time.

Other embodiments and variations than the embodiments described above are of course possible within the scope of the invention. For example, the shape of the protective housing 3 and the device holder 4 could be varied in a number of ways, providing different shapes to the outer wall 10 of the package, such as cylindrical, polygonal etc.

Also, several different parts could constitute the protective housing 3. All or one of the protective housing parts could be movable relative to the device holder. If several protective housing parts are movable, they could be movable in the same or in different directions relative to the device holder.

The device holder 4 should be movable relative to the protective housing 3 according to the present invention. Naturally, this comprises both solutions where one would hold the device holder fixed and set the protective housing in motion and solutions where one would hold the protective housing fixed and set the device holder in motion.

The guide means could, apart from the sliding means described above, be constructed, for example, by means of internal/external screw-threads or using hinges.

In the embodiments described above, the device holder and the protective housing are set into motion by directly manipulating the device holder and/or the protective housing. It is also possible to actuate the motion between the storage position and a removal position by i) connecting the device to an extraction tool ii) pulling the tool so that the device and the device holder are moved relative to the protective housing.

The man skilled in the art could easily imagine different forms of gripping means, snap lock means, holding means etc to be used with the invention.

Another possible embodiment of the invention could comprise an elongate housing, having a length being about twice the length of the device holder. The housing could be provided with a lateral opening, located in an upper half of the housing. When in the storage position, the device holder would be situated in a lower half of the housing, so that the device is well protected by the protective housing. The device holder could be movable from the storage position to a removal position, where the device holder is located in the upper half of the protective housing, and where the device is removable through said lateral opening. For such an embodiment, the guide means could be constructed as in the second (FIG. 2a) or fourth (FIG. 4) embodiment above.

Although the embodiments of the invention described in the application are containing implants, the invention is not limited to such use. Naturally, a packaged could be designed according to the invention to contain other devices, in particular devices for use with implants such as dental abutments, cover screws or the like.

1. A package (1) for a device (2), particularly an implant, comprising a protective housing (3), characterised by a device holder (4) arranged to support the device (2) and connected to said protective housing (3) for movement in relation thereto between a device storage position, in which said device is protected by the protective housing, and a device removal position; and guide means (5) defining a predetermined path (6) for said movement of the device holder (4) in relation to said protective housing (3), said predetermined path (6) being arranged so that the device (2), when supported by the device holder (4), is kept apart from the protective housing (3).

2. A package (1) according to claim 1, wherein said device removal position is a position in which the device (2), when supported by the device holder (4), is located completely outside the protective housing (3).

3. A package (1) according to claim 1, wherein said device removal position is a position in which the device (2), when supported by device holder (4), is located partly outside the protective housing (3).

4. A package (1) according to claim 3, wherein said device removal position is a position in which a major part of the device (2), when supported by the device holder (4), is located outside the protective housing (3).

5. A package (1) according to any one of claims 1-4, wherein said device removal position is a position in which the device holder (4) is at least partly located outside the protective housing (3) as seen in the direction of said movement.

6. A package (1) according to any one of claims 1-5, wherein said device removal position is a position in which the device holder (4) extends from the protective housing (3) so that the device (2) is accessible in the device holder (4).

7. A package (1) according to any one of claims 1-6, wherein the protective housing (3) is provided with an opening which extends (9) transversely to said predetermined path (6) and through which opening (9) the device holder (4) is movable between said device storage position and said device removal position.

8. A package according to claim 7, wherein said protective housing (3) has an elongated shape with a short end presenting said opening (9).

9. A package (1) according to claim 7 or 8, wherein said protective housing (3) has an elongated shape and said predetermined path (6) is directed essentially parallel to a longitudinal direction of the protective housing (3).

10. A package (1) according to any one of claims 1-9, wherein said movement of the device holder (4) is a sliding movement.

11. A package (1) according to claim 10, wherein said guide means (5) comprise a slide track (8) and a slide member (7) movable along said slide track (8).

12. A package (1) according to claim 11, wherein adjacent portions of the protective housing(3) and the device holder (4), respectively, have complementary shapes forming said slide member (7) and said slide track (8) or vice versa.

13. A package (1) according to claim 11 or 12, wherein the slide track (8) is arranged on the protective housing (3) and the slide member (7) is arranged on the device holder (4).

14. A package (1) according to any one of claims 1-13, wherein the protective housing (1) forms an outer wall (10) of the package (1), and wherein the device holder (4) is provided adjacent to said outer wall (10), so that the device (2), when supported by the device holder (4), is protected by said outer wall (10) when the device holder (4) is in the device storage position.

15. A package (1) according to any one of claims 1-13, wherein, when the device holder (4) is in said device storage position, the package (1) has an outer wall (10), the protective housing (3) comprises a first wall part (10′), and the device holder (4) comprises a second wall part (10″), such that the first wall part (10′) and the second wall part (10″) together form said outer wall (10) for protecting the device (2) when the device holder (4) is in said device storage position.

16. A package (1) according to claim 15, wherein, when the device holder (4) is in the storage position, the package (1) has the outer wall (10) presenting four side walls, the protective housing (3) comprises the first wall part (10′) having three side walls, and the device holder (4) comprises the second wall part (10″) having one side wall, such that the first wall part (10′) and the second wall part (10″) together form said outer wall (10) having four side walls for protecting the device (2) when the device holder (4) is in the device storage position.

17. A package (1) according to any one of claims 1-16, wherein at least one of the protective housing (3) and the device holder (4) is provided with gripping means (11) for facilitating said movement of the device holder (4).

18. A package (1) according to any one of claims 1-17, wherein the protective housing (3) is provided with an access opening in which a part of the device (2), when supported by the device holder (4), is accessible when the device holder (4) is in said device storage position.

19. A package (1) according to any one of claims 1-18, wherein the device holder (4) is arranged to support the device (2) from a generally transverse direction relative to a longitudinal direction of the device (2).

20. A package (1) according to any one of claims 1-19, further comprising locking means (13) arranged to prevent unintentional movement of the device holder (4) from said device storage position.

21. A package (1) according to any one of claims 1-20, further comprising locking means (13) arranged to prevent separation of the device holder (4) from the protective housing (3).

22. A package (1) according to claim 20 or 21, wherein said locking means (13) are mechanical locking means.

23. A package (1) according to claim 20 or 21, wherein said locking means (13) are frictionally enhancing means.

24. A package (1) according to claims 20 or 21, wherein said locking means (13) are snap lock means.

25. A package (1) according to any of the preceding claims in combination with a device (2) supported by the device holder (4).
